(19) United States
(12) Patent Application Publication
(10) Pub. No.: US 2007/0044246 A1
(43) Pub. Date: Mar. 1, 2007

(54) Leather garment

(76) Inventor: Joseph Faris, Troy, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/216,262

(22) Filed: Aug. 31, 2005

(51) Int. Cl. C14C 1/06

(52) U.S. Cl. 8/94.16

(57) ABSTRACT

A leather garment formed by the process of removing substantially all exogenous chemicals from the hide. The hide is then tanned without introducing any exogenous chemicals into the hide. After tanning, a pattern is tattooed onto the tanned hide.

### BACKGROUND OF THE INVENTION

I. Field of the Invention

The present invention relates generally to garments and, more particularly, to a tattooed leather garment.

II. Description of Related Art

During the preparation of leather garments of all types, the animal hide is first removed from the animal. Thereafter, the animal hide is submerged within a preservative solution commonly known in the industry as “wet blue.” With the hide in this preservative solution, it is shipped to a tannery.

At the tannery, the tannery typically treats the leather hide with exogenous chemicals, such as chrome, in order to impart color and other properties to the hide. These exogenous chemicals enter the pores of the animal hide and remain trapped within those pores.

Thereafter, the tanner dries out the hide and the dried hides are relatively stiff. In order to soften the hides so that they may be worn as garments, the hides are typically placed within a drum which mechanically impacts and softens the hide.

In many situations, it is desirable to have a pattern imprinted in some fashion on the hide. In some cases, the pattern is simply painted onto the hide using the selected colors for the pattern and allowed to dry. This particular method for imprinting a pattern onto the hide, however, has not proven wholly satisfactory.

The primary disadvantage of simply painting a pattern onto the hide is that the paint merely lies on the outer surface of the hide and covers it. In doing so, the paint provides a different texture than the remaining unpainted portions of the hide. Furthermore, the painted portions are oftentimes either more glossy or less glossy than the hide itself, thus producing an undesirable visual contrast with the unpainted portions of the hide.

A still further disadvantage of simply painting patterns onto the tanned hides is that the paint, after extended use of the garment, may chip away from the hide due to the constant flexion of the garment by the user. Such patterns of chipped paint provide an undesirable and unsightly visual impact.

In order to overcome these previously known problems of painting patterns onto the leather hide, there have been previous attempts to tattoo the tanned hide with the desired pattern. Such attempts, however, have not proven satisfactory.

More specifically, attempts to tattoo the hides using ink needles embedded into the hide have heretofore resulted in blurred lines from the tattoo since the injected ink is unable to maintain the sharp pattern of the tattoo following the injection of the ink. Instead, after injection of the ink by tattoo needles into the hide, the ink tends to run outwardly from the injection site, thus forming a blurry, spotted and unacceptable pattern.

The exact the reason that the animal hides tanned by the previously known processes have been unable to be satisfactorily tattooed is not precisely known. However, it is believed that the exogenous chemicals introduced into the pores of the animal hide during the tanning process partially or totally fill the pores of the animal hide. Consequently, upon an injection of ink by the tattoo needles, the pores are unable to accept the tattoo ink, instead dispersing the ink laterally outwardly from the injection site on the hide and resulting in the acceptably blurred pattern.

### SUMMARY OF THE PRESENT INVENTION

The present invention provides a leather garment and method for making the leather garment which overcomes all of the above-mentioned disadvantages of the previously known devices.

In brief, following removal of the hide from an animal, the animal hide is immersed in a preservative solution. This preservative solution is commonly known at “wet blue,” although other preservative solutions may alternatively be used without deviation from the present invention. After immersion of the removed hides in the preservative, the hides are shipped to a tannery.

At the tannery, the hide is rinsed of the preservatives and then dried without introducing any exogenous chemicals into the hide. Optionally, the hide is also subjected to a bleach to remove any exogenous chemicals which may be contained within the hide resulting from the preservative solution.

After the hide has been rinsed and dried, it is softened in the conventional fashion, i.e. by processing it in a drum. Thereafter, the tanned hide, free of exogenous chemicals, is ready for tattooing using conventional tattoo needles.

In order to tattoo the hide, a petroleum jelly is wiped onto the hide in the area where the pattern is desired. Thereafter, conventional tattoo needles using conventional tattoo ink are applied against the hide to form the desired pattern.

At the completion of the tattooing process, the petroleum jelly is removed from the hide, thus leaving the tattoo intact on the hide. Furthermore, since the hide is free of exogenous chemicals, the tattoo ink is able to enter into the pores of the animal hide without the previously known lateral disbursement of the ink through the hide as caused by the previously known tanning operations.

After the petroleum jelly has been cleaned from the hide, the tattooed pattern remains on the hide. Furthermore, since the tattooed pattern is actually formed below the outer surface of the hide, the portion of the hide containing the pattern retains the same reflectivity and outward appearance as the remaining untattooed portions of the hide.

### BRIEF DESCRIPTION OF THE DRAWING

A better understanding of the present invention will be had upon reference to the following detailed description when read with the accompanying drawing, wherein like reference characters refer to like parts throughout the several views, and in which:

FIG. 1 is a flow diagram illustrating the present invention; and

FIG. 2 is an elevational view illustrating the preferred embodiment of the present invention.

### DETAILED DESCRIPTION OF A PREFERRED EMBODIMENT OF THE PRESENT INVENTION

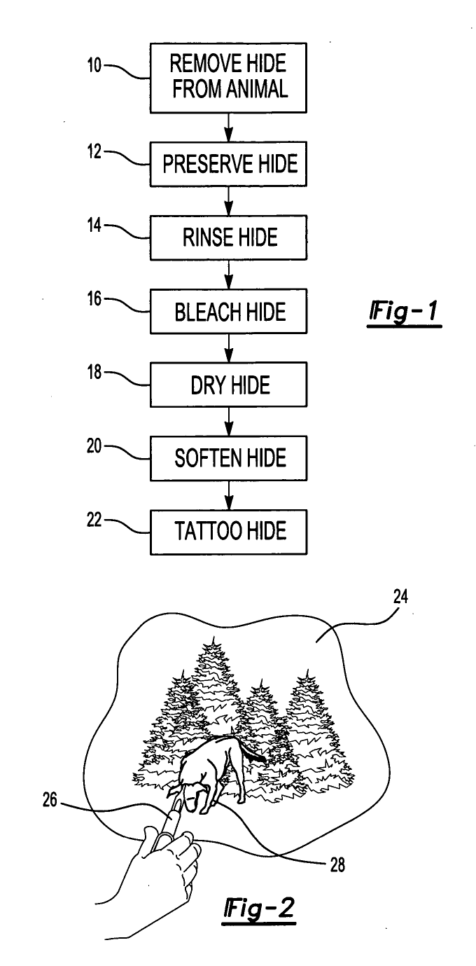

With reference first to FIG. 1, at step 10, a hide is first removed from an animal. The animal may be any type of animal, such as cattle, and the like. Step 10 then proceeds to step 12.

At step 12, the removed animal hide is submerged within a preservative solution. One type of preservative solution is known as “wet blue” in the tanning industry. Other types of preservative solutions, however, may alternatively be used without deviation from the spirit or scope of the invention.

The preserved hide is then typically shipped to a tannery where the tannery first rinses the preservative solution from the hide at step 14. This rinsing step 14 not only removes the preservative from the hide, but also does so without introducing any exogenous chemicals, such as chrome, into the hide. Typically, the rinsing solution used at step 14 comprises a water-based rinsing solution.

After the hide is rinsed at step 14, the hide is optionally bleached at step 16. The bleaching step of 16 is performed without introducing exogenous materials into the hide which are now removed from the hide following the bleaching step 16. Furthermore, the bleaching step 16 serves not only to lighten the appearance of the hide without the introduction of exogenous chemicals, but also serves to remove any exogenous chemicals that may still be present in the hide from the preservation step 12.

The hide is then dried at step 18. Following the drying step 18, the hide is typically quite stiff. Therefore, step 18 proceeds to step 20 where the hide is softened during the tanning process, typically by processing the hide in a drum or other mechanical softening mechanisms. Furthermore, following the softening step, the hide is totally tanned.

After tanning the hide as described above, the hide is ready for tattooing and the hide proceeds to the step of 22 of tattooing the hide. Furthermore, the step 22 of tattooing the hide is performed in the conventional fashion. More specifically, as shown in FIG. 2, the hide 24 is first covered with a petroleum jelly and, thereafter, conventional tattoo needles 26 are used to imprint a pattern 28 into the hide 24. Following the tattooing operation, the petroleum jelly on the hide, together with any ink entrained within the petroleum jelly, is removed from the hide 24, thus leaving the pattern 28 within the pores of the hide 24.

From the foregoing, it can be seen that the present invention provides both a garment and method for manufacturing a garment from leather which is tattooed. It will, of course, be appreciated that garments may be sold without a tattoo which allows the purchaser of those garments to individualize his or her garment with his or her selection of tattoos. As such, each garment may be uniquely customized by the purchaser.

Since all exogenous chemicals are removed, or at least substantially removed, from the hide during the tanning process, it has been discovered that the ink injected by the tattoo needles during the tattooing process remains at the injection site within the pores of the hide. As such, patterns may be tattooed onto the hide which retains sharp tattoo lines without blurring or other undesirable effects. Different colors of tattoo ink, of course, may be used as desired.

From the foregoing, it can be seen that the present invention provides a unique and user customizable leather garment capable of receiving a tattoo without blurring. Having described my invention, however, many modifications thereto will become apparent to those skilled in the art to which it pertains without deviation from the spirit of the invention as defined by the scope of the appended claims.

I claim:

1. A method of manufacturing a leather garment comprising the steps of:
placing an animal hide in a preservative solution,
thereafter rinsing the preservative from the animal hide,
softening the animal hide, and
tattooing the animal hide.

2. The invention as defined in claim 1 and further comprising the step of drying the animal hide after said rinsing step and before said softening step.

3. The invention as defined in claim 1 and further comprising the step of bleaching the animal hide after said rinsing step.

4. The invention as defined in claim 1 wherein said rinsing step removes substantially all exogenous chemicals from said animal hide.

5. A method of preparing an animal hide for tattooing comprising the steps of:
removing substantially all exogenous chemicals from the hide,
tanning the hide without adding exogenous chemicals into the hide.

6. The invention as defined in claim 5 wherein said removing step comprises the step of bleaching the hide.

7. A leather garment formed by the steps of:
removing substantially all exogenous chemicals from the hide,
tanning the hide without introducing exogenous chemicals into the hide, and
tattooing a pattern onto the tanned hide.

8. The invention as defined in claim 7 wherein said removing step comprises the step of rinsing the hide.
